(19) United States
(12) Patent Application Publication
(10) Pub. No.: US 2025/0171643 A1
(43) Pub. Date: May 29, 2025

(54) POLYMER AND COATING MATERIAL

(71) Applicant: INDUSTRIAL TECHNOLOGY RESEARCH INSTITUTE, Hsinchu (TW)

(72) Inventors: Shu-Ling YEH, Zhubei City (TW); Su-Mei CHEN WEI, Hsinchu City (TW); Chien-Chen CHU, New Taipei City (TW); Wei-Cheng TANG, Hsinchu City (TW); Yi-Che SU, Zhubei City (TW)

(73) Assignee: INDUSTRIAL TECHNOLOGY RESEARCH INSTITUTE, Hsinchu (TW)

(21) Appl. No.: 18/913,654

(22) Filed: Oct. 11, 2024

(30) Foreign Application Priority Data
Nov. 28, 2023 (TW) 112145961

(51) Int. Cl. C09D 5/02; C08F 220/18; C08F 222/02; C08F 222/14; C09D 133/06; C09D 135/02

(52) U.S. Cl. CPC C09D 5/022; C08F 220/1808; C08F 220/1811; C08F 220/1812; C08F 222/02; C08F 222/14; C09D 133/064; C09D 135/02; C08F 2800/20

(57) ABSTRACT

A polymer and a coating material are provided. The polymer is formed by polymerizing a plurality of monomers. The monomers include a first monomer, a second monomer, and a third monomer. The first monomer is itaconic acid. The second monomer is C₁₋₄ alkyl methacrylate, styrene, isobornyl acrylate, di(C₂₋₄ alkyl) itaconate, or a combination thereof. The third monomer is 2-octylacrylate, C₉₋₁₂ alkyl acrylate, or a combination thereof. The coating material includes the polymer.

### CROSS REFERENCE TO RELATED APPLICATION

The present application is based on, and claims priority from, Taiwan Application Serial Number 112145961, filed on Nov. 28, 2023, the disclosure of which is hereby incorporated by reference herein in its entirety.

### TECHNICAL FIELD

The technical field relates to a polymer.

### BACKGROUND

Replacing solvent with water in several fields (e.g., coating materials, adhesives, molding materials, medical materials, electronic materials) has become a trend and is done to improve both working environment and safety. However, most common aqueous coating materials exhibit poor adhesion to metal substrates and shrink after drying. In addition, the combination of these conventional aqueous resins and pigment powder usually requires the addition of a dispersant to form a coating material without agglomeration.

Accordingly, a novel aqueous (waterborne) resin is called for to address the issues mentioned above.

### SUMMARY

One embodiment of the disclosure provides a polymer formed by polymerizing a plurality of monomers, and the monomers include a first monomer, a second monomer, and a third monomer. The first monomer is itaconic acid. The second monomer is C₁₋₄ alkyl methacrylate, styrene, isobornyl acrylate, di(C₂₋₄ alkyl) itaconate, or a combination thereof. The third monomer is 2-octylacrylate, C₉₋₁₂ alkyl acrylate, or a combination thereof.

One embodiment of the disclosure provides a coating material, including 100 parts by weight of the described polymer; and 100 to 700 parts by weight of water.

A detailed description is given in the following embodiments.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

One embodiment of the disclosure provides a polymer formed by polymerizing a plurality of monomers, and the monomers include a first monomer, a second monomer, and a third monomer. The first monomer is itaconic acid. The second monomer is C₁₋₄ alkyl methacrylate, styrene, isobornyl acrylate, di(C₂₋₄ alkyl) itaconate, or a combination thereof. The third monomer is 2-octylacrylate, C₉₋₁₂ alkyl acrylate, or a combination thereof.

The first monomer and the second monomer form the hard segment of the polymer, and the third monomer forms the soft segment of the polymer. In some embodiments, the ratio of the total weight of the first monomer and the second monomer to the weight of the third monomer is (i.e., the weight ratio of hard segment to soft segment) 150:20 to 400:1200.

In some embodiments, the first monomer and the second monomer have a weight ratio of 100:40 to 100:1600.

In some embodiments, the first monomer and the third monomer have a weight ratio of 100:50 to 100:1900.

In some embodiments, the C₁₋₄ alkyl methacrylate can be methyl methacrylate or another suitable alkyl methacrylate. In some embodiments, the di(C₂₋₄ alkyl) itaconate can be dibutyl itaconate or another suitable dialkyl itaconate. In some embodiments, the C₉₋₁₂ alkyl acrylate can be lauryl acrylate or another suitable alkyl acrylate.

The described polymer is aqueous resin which can be self-emulsified in water to form an emulsion. The formed emulsion can be applied as a coating material.

One embodiment of the disclosure provides a coating material, including 100 parts by weight of the described polymer and 100 to 700 parts by weight of water. The water can be the water used for synthesizing the polymer. In some embodiments, additional water can be further added. If the water amount is too low, the coating material will easily agglomerate. If the water amount is too high, the coating material will be too dilute to adhere tightly onto the substrate.

In some embodiments, the coating material further includes 0.1 to 200 parts by weight of pigment powder. If the pigment powder amount is too high, it may agglomerate and cannot be dispersed. For example, the pigment powder can be yellow inorganic pigment such as cadmium yellow (PY35, C.I.77205, CAS No.: 12237-67-1), titanium nickel yellow (PY53, C.I.77788, CAS No.: 8007-18-9), praseodymium zirconium yellow (PY159, C.I.77997, CAS No.: 68187-15-5), chromium titanium yellow (PY162, C.I.77896, CAS No.: 68611-42-7; PY163, C.I.77897, CAS No.: 68186-92-5), or bismuth yellow (PY184, C.I.771740, CAS No.: 14059-33-7); magenta inorganic pigment such as iron red (PR101, C.I.77491, CAS No.: 1317-60-8), cadmium red (PR108, C.I.77202, CAS No.: 58339-34-7), lead chromium red (PR104, C.I.77605, CAS No.: 12656-85-8; PR105, C.I.77578, CAS No.: 1314-41-6), or iron zirconium red (PR232, C.I.77996, CAS No.: 68412-79-3); cyan inorganic pigment such as cobalt blue (PB28, C.I.77364, CAS No.:68187-40-6) or cobalt chromium blue (PB36, C.I.77343, CAS No.:68187-11-1); black inorganic pigment such as manganese iron black (PBK26, C.I.77494, CAS No.:68186-94-7; PBK33, C.I.77537, CAS No.: 75864-23-2), cobalt iron chromium black (PBK27, C.I.77502, CAS No.:68186-97-0), copper chromium black (PBK28, C.I.77428, CAS No.:68186-91-4), chromium iron black (PBK30, C.I.77504, CAS No.: 71631-15-7), or titanium black (PBK35, C.I.77890, CAS No.: 70248-09-8); white inorganic pigment such as titanium white (PW6, C.I.77891, CAS No.: 13463-67-7), zirconium white (PW12, C.I.77990, CAS No.: 1314-23-4), or zinc white (PW4, C.I.77947, CAS No.: 1314-13-2); orange inorganic powder such as cadmium orange (P020, C.I.77199, CAS No.: 12656-57-4) or orange chromium yellow (P021, C.I.77601, CAS No.: 1344-38-3); or green inorganic pigment such as chromium green (PG17, C.I.77288, CAS No.: 1308-38-9), cobalt green (PG19, C.I.77335, CAS No.: 8011-87-8), cobalt chromium green (PG26, C.I.77344, CAS No.: 68187-49-5), or cobalt titanium green (PG50, C.I.77377, CAS No.: 68186-85-6). In some embodiments, the pigment powder is titanium white such as titanium dioxide.

In some embodiments, the coating material further includes 0.1 to 20 parts by weight of film forming agent, defoamer, dispersant, levelling agent, or a combination thereof to further improve the properties of the coating material. If the amount of the film forming agent, defoamer, dispersant, levelling agent, or a combination thereof is too high, the properties of the coating material will be negatively influenced (e.g. fog and peeling possibly occur).

The coating material has a good film formability and a good adhesion to a metal substrate. In addition, the coating material can be stored for a long time, and the coating layer formed from the coating material has a good antistatic property. Because the polymer can be synthesized in water without organic solvent, the process is environmental friendly. Furthermore, the raw materials of the polymer contain itaconic acid, thereby increasing the biomass content of the polymer.

Below, exemplary embodiments will be described in detail so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

In following Examples, the surfactant for preparing the polymer could be anionic surfactant, cationic surfactant, non-ionic surfactant, or a combination thereof to help the polymerization. One skilled in the art may select any kind of the surfactant according to his/her requirements.

In following Examples, the emulsion was put in an oven at 120° C. for 3 hours to measure the weight difference of the emulsion before and after baking to calculate the solid content of the emulsion. The thermal decomposition temperature (Td) of the polymer was measured by thermogravimetric analysis (TGA). The viscosity of the emulsion was measured by Brookfield KU-2 Viscometer. The film-forming temperature of the emulsion was measured according to the standard ISO 2115:1996. The film formability of the emulsion was confirmed by visually inspecting whether the emulsion coated on the substrate shrinks. The surface resistances of the film formed from the emulsion under different humidity were measured according to the standard ANSI/ESD STM11.11-2015. The adhesion of the film formed from the emulsion was measured by a cross-cut tape method (ASTM D3359). The stability (Turbiscan stability index, TSI) of the mixture of the emulsion and the titanium oxide powder was measured by a dispersion stability analyzer, in which the sample was put into the analyzer to measure 24 hours for calculating the change of the sample.

### Example 1

22 parts by weight of itaconic acid, 16 parts by weight of methyl methacrylate, 62 parts by weight of 2-octyl acrylate, and 10 parts by weight of surfactant were added into 100 parts by weight of water and then thoroughly stirred. Subsequently, 0.6 parts by weight of ammonium persulfate (an initiator) was added thereto, stirred and heated to 75° C. to react for 5 hours to obtain a polymer. The polymer was dispersed in water to form an emulsion with a solid content of 37.74%. The polymer had a thermal decomposition temperature of 350° C. The emulsion had a viscosity of 159 cps. The emulsion had a film-forming temperature of 11° C. and good film formability. The film had a surface resistance of 10⁵ Ω/□ at 25° C. under a relative humidity of 60%, and a surface resistance of 10⁶Ω/□ at 25° C. under a relative humidity of 30%. The lower surface resistance of the film means the better antistatic property of the film. The emulsion was coated onto metal substrates including an aluminum plate and a galvanized steel plate respectively and then dried to form films. Both films had adhesion of 5B without shrinkage.

### Example 2

15 parts by weight of itaconic acid, 13 parts by weight of methyl methacrylate, 72 parts by weight of lauryl acrylate, and 10 parts by weight of surfactant were added into 100 parts by weight of water and then thoroughly stirred. Subsequently, 0.6 parts by weight of ammonium persulfate (an initiator) was added thereto, stirred and heated to 75° C. to react for 5 hours to obtain a polymer. The polymer was dispersed in water to form an emulsion with a solid content of 43.26%. The emulsion had a film-forming temperature of 11° C. and good film formability. The film had a surface resistance of 10⁵ Ω/□ at 25° C. under a relative humidity of 60%, and a surface resistance of 10⁶Ω/□ at 25° C. under a relative humidity of 30%. The emulsion was coated onto metal substrates including an aluminum plate and a galvanized steel plate respectively and then dried to form films. Both films had adhesion of 5B without shrinkage.

### Example 3

5 parts by weight of itaconic acid, 23 parts by weight of dibutyl itaconate, 15 parts by weight of methyl methacrylate, 57 parts by weight of lauryl acrylate, and 10 parts by weight of surfactant were added into 100 parts by weight of water and then thoroughly stirred. Subsequently, 0.6 parts by weight of ammonium persulfate (an initiator) was added thereto, stirred and heated to 75° C. to react for 5 hours to obtain a polymer. The polymer was dispersed in water to form an emulsion with a solid content of 45.60%. The emulsion had a film-forming temperature of 4° C. and good film formability. The film had a surface resistance of 10⁵ Ω/□ at 25° C. under a relative humidity of 60%, and a surface resistance of 10⁶Ω/□ at 25° C. under a relative humidity of 30%. The emulsion was coated onto metal substrates including an aluminum plate and a galvanized steel plate respectively and then dried to form films. Both films had adhesion of 5B without shrinkage.

### Example 4

40 parts by weight of itaconic acid, 40 parts by weight of dibutyl itaconate, 20 parts by weight of lauryl acrylate, and 10 parts by weight of surfactant were added into 100 parts by weight of water and then thoroughly stirred. Subsequently, 0.6 parts by weight of ammonium persulfate (an initiator) was added thereto, stirred and heated to 60° C. to react for 2 hours to obtain a polymer. The polymer was dispersed in water to form an emulsion with a solid content of 35.40%. The emulsion had a film-forming temperature of 35° C. and a good film formability. The film had a surface resistance of 10⁵Ω/□ at 25° C. under a relative humidity of 60%, and a surface resistance of 10⁵Ω/□ at 25° C. under a relative humidity of 30%.

### Example 5

40 parts by weight of itaconic acid, 20 parts by weight of methyl methacrylate, 40 parts by weight of 2-octyl acrylate, and 10 parts by weight of surfactant were added into 100 parts by weight of water and then thoroughly stirred. Subsequently, 0.6 parts by weight of ammonium persulfate (an initiator) was added thereto, stirred and heated to 75° C. to react for 5 hours to obtain a polymer. The polymer was dispersed in water to form an emulsion with a solid content of 33.54%. The emulsion had a film-forming temperature of 40° C. and a good film formability. The film had a surface resistance of 105Ω/□ at 25° C. under a relative humidity of 60%, and a surface resistance of 105Ω/□ at 25° C. under a relative humidity of 30%.

### Example 6

5 parts by weight of itaconic acid, 11 parts by weight of methyl methacrylate, 15 parts by weight of styrene, 18 parts by weight of isobornyl acrylate, 51 parts by weight of lauryl acrylate, and 10 parts by weight of surfactant were added into 100 parts by weight of water and then thoroughly stirred. Subsequently, 0.6 parts by weight of ammonium persulfate (an initiator) was added thereto, stirred and heated to 75° C. to react for 5 hours to obtain a polymer. The polymer was dispersed in water to form an emulsion with a solid content of 43.29%. The emulsion had a film-forming temperature of 28.6° C. and a good film formability. The film had a surface resistance of 10⁶Ω/□ at 25° C. under a relative humidity of 60%, and a surface resistance of 10⁷Ω/□ at 25° C. under a relative humidity of 30%.

### Example 7

5 parts by weight of itaconic acid, 16 parts by weight of methyl methacrylate, 20 parts by weight of styrene, 44 parts by weight of isobornyl acrylate, 15 parts by weight of lauryl acrylate, and 10 parts by weight of surfactant were added into 100 parts by weight of water and then thoroughly stirred. Subsequently, 0.6 parts by weight of ammonium persulfate (an initiator) was added thereto, stirred and heated to 60° C. to react for 2 hours to obtain a polymer. The polymer was dispersed in water to form an emulsion with a solid content of 45.09%. The emulsion had a film-forming temperature of 50.2° C. and a good film formability. The film had a surface resistance of 10⁶Ω/□ at 25° C. under a relative humidity of 60%, and a surface resistance of 10⁷Ω/□ at 25° C. under a relative humidity of 30%.

### Example 8

40 parts by weight of itaconic acid, 20 parts by weight of styrene, 40 parts by weight of lauryl acrylate, and 10 parts by weight of surfactant were added into 100 parts by weight of water and then thoroughly stirred. Subsequently, 0.6 parts by weight of ammonium persulfate (an initiator) was added thereto, stirred and heated to 75° C. to react for 5 hours to obtain a polymer. The polymer was dispersed in water to form an emulsion with a solid content of 32.04%. The emulsion had a film-forming temperature of 45.2° C. and a good film formability. The film had a surface resistance of 10⁶Ω/□ at 25° C. under a relative humidity of 60%, and a surface resistance of 10⁷Ω/□ at 25° C. under a relative humidity of 30%.

### Comparative Example 1

A commercially available aqueous coating emulsion (its polymer containing—COOH, which was confirmed by titration) had a film-forming temperature of 17° C. and a good film formability. The film had a surface resistance of 10¹¹Ω/□ at 25° C. under a relative humidity of 60%, and a surface resistance of 10¹¹Ω/□ at 25° C. under a relative humidity of 30%. The emulsion was coated onto metal substrates including an aluminum plate and a galvanized steel plate respectively and then dried to form films. Both films had adhesion of GB with shrinkage. As known from Comparative Example 1, the films formed from the emulsion in Examples of the disclosure had lower surface resistances (i.e. better antistatic property) and better adhesion to the metal substrate such as the aluminum plate than that of the film formed from the commercially available emulsion.

### Comparative Example 2

7 parts by weight of itaconic acid, 22 parts by weight of acrylic acid, 70 parts by weight of lauryl acrylate, and 10 parts by weight of surfactant were added into 100 parts by weight of water and then thoroughly stirred. Subsequently, 0.6 parts by weight of ammonium persulfate (an initiator) was added thereto, stirred and heated to 75° C. to react for 5 hours to obtain a polymer. The polymer was agglomerated and could not be dispersed in water. As known in Comparative Example 2, not any monomer could be combined with itaconic acid to form the aqueous polymer.

### Comparative Example 3

5 parts by weight of itaconic acid, 23 parts by weight of dibutyl itaconate, 15 parts by weight of methyl methacrylate, 57 parts by weight of 2-ethylhexyl acrylate, and 10 parts by weight of surfactant were added into 100 parts by weight of water and then thoroughly stirred. Subsequently, 0.6 parts by weight of ammonium persulfate (an initiator) was added thereto, stirred and heated to 75° C. to react for 5 hours to obtain a polymer. The polymer was agglomerated and could not be dispersed in water. As known in Example 3 and Comparative Example 3, not any monomer could be combined with itaconic acid to form the aqueous polymer.

### Example 9

30 parts by weight of the emulsion in Example 1, 30 parts by weight of titanium dioxide serving as pigment powder, and 6.6 parts by weight of a wetting dispersant (containing polysiloxane solution and ester alcohol) were mixed to form a coating material. The coating material was coated onto metal substrates including an aluminum plate and a galvanized steel plate respectively and then dried to form films. Both films had adhesion of 5B.

### Example 10

30 parts by weight of the emulsion in Example 2, 30 parts by weight of titanium dioxide serving as pigment powder, and 6.6 parts by weight of a wetting dispersant (containing polysiloxane solution and ester alcohol) were mixed to form a coating material. The coating material was coated onto metal substrates including an aluminum plate and a galvanized steel plate respectively and then dried to form films. Both films had adhesion of 5B.

### Example 11

30 parts by weight of the emulsion in Example 3, 30 parts by weight of titanium dioxide serving as pigment powder, and 6.6 parts by weight of a wetting dispersant (containing polysiloxane solution and ester alcohol) were mixed to form a coating material. The coating material was coated onto metal substrates including an aluminum plate and a galvanized steel plate respectively and then dried to form films. Both films had adhesion of 5B. The coating material had a TSI of 23.

Alternatively, 30 parts by weight of the emulsion in Example 3 and 60 parts by weight of titanium dioxide serving as pigment powder were mixed to form a coating material. This coating material was a stable dispersion without agglomeration, i.e. the polymer itself in the emulsion could disperse the titanium dioxide, and additional wetting dispersant was not required.

### Comparative Example 4

30 parts by weight of the commercially available aqueous emulsion, 30 parts by weight of titanium dioxide serving as pigment powder, and 10 parts by weight of a wetting dispersant (containing polysiloxane solution and ester alcohol) were mixed to form a coating material. The coating material was coated onto metal substrates including an aluminum plate and a galvanized steel plate respectively and then dried to form films. Both films had adhesion of GB. The coating material had a TSI of 30, such that its stability was lower than that of the coating material in Example 11. The lower TSI means the higher stability.

Alternatively, 30 parts by weight of the commercial available emulsion and 30 parts by weight of titanium dioxide serving as pigment powder were mixed and agglomerate was generated. The polymer in the emulsion had a poor dispersion effect to the titanium dioxide, thereby needing additional wetting dispersant to disperse the titanium dioxide.

### Comparative Example 5

20 parts by weight of methyl methacrylate, 41 parts by weight of dibutyl itaconate, 39 parts by weight of 2-octyl acrylate, and 10 parts by weight of surfactant were added into 100 parts by weight of water and then thoroughly stirred. Subsequently, 0.6 parts by weight of ammonium persulfate (an initiator) was added thereto, stirred and heated to 75° C. to react for 5 hours to obtain a polymer. The polymer was dispersed in water to form an emulsion with a solid content of 43.99%.

30 parts by weight of the emulsion, 30 parts by weight of titanium dioxide serving as pigment powder, and 6.6 parts by weight of a wetting dispersant (containing polysiloxane solution and ester alcohol) were mixed to form a coating material. The coating material was coated onto metal substrates including an aluminum plate and a galvanized steel plate respectively and then dried to form films. Both films had poor film formability and shrinkage. As known from Comparative Example 5, the film obtained from the polymer formed from monomers lacking itaconic acid easily shrank.

### Comparative Example 6

48.75 parts by weight of methyl methacrylate, 2.5 parts by weight of acrylic acid, 48.75 parts by weight of butyl acrylate, and 10 parts by weight of surfactant were added into 100 parts by weight of water and then thoroughly stirred. Subsequently, 0.6 parts by weight of ammonium persulfate (an initiator) was added thereto, stirred and heated to 75° C. to react for 5 hours to obtain a polymer. The polymer was dispersed in water to form an emulsion with a solid content of 44.95%.

30 parts by weight of the emulsion, 30 parts by weight of titanium dioxide serving as pigment powder, and 10 parts by weight of a wetting dispersant (containing polysiloxane solution and ester alcohol) were mixed to form a coating material. The coating material was coated onto metal substrates including an aluminum plate and a galvanized steel plate respectively and then dried to form films. Both films had poor film formability and shrinkage. As known from Comparative Example 6, the film obtained from the polymer formed from monomers lacking itaconic acid easily shrank

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A polymer, being
formed by polymerizing a plurality of monomers, wherein the monomers include a first monomer, a second monomer, and a third monomer,
wherein the first monomer is itaconic acid;
the second monomer is C₁₋₄ alkyl methacrylate, styrene, isobornyl acrylate, di(C₂₋₄ alkyl) itaconate, or a combination thereof; and
the third monomer is 2-octylacrylate, C₉₋₁₂ alkyl acrylate, or a combination thereof.

2. The polymer as claimed in claim 1, wherein a total weight of the first monomer and the second monomer to a weight of the third monomer have a ratio of 150:20 to 400:1200.

3. The polymer as claimed in claim 1, wherein the first monomer and the second monomer have a weight ratio of 100:40 to 100:1600.

4. The polymer as claimed in claim 1, wherein the first monomer and the third monomer have a weight ratio of 100:50 to 100:1900.

5. The polymer as claimed in claim 1, wherein the C₁₋₄ alkyl methacrylate comprises methyl methacrylate.

6. The polymer as claimed in claim 1, wherein the di(C₂₋₄ alkyl) itaconate comprises dibutyl itaconate.

7. The polymer as claimed in claim 1, wherein the C₉₋₁₂ alkyl acrylate comprises lauryl acrylate.

8. A coating material, comprising:
100 parts by weight of the polymer as claimed in claim 1; and
100 to 700 parts by weight of water.

9. The coating material as claimed in claim 8, further comprising 0.1 to 200 parts by weight of pigment powder.

10. The coating material as claimed in claim 8, further comprising 0.1 to 20 parts by weight of a film forming agent, defoamer, dispersant, levelling agent, or a combination thereof.
